(19) United States
(12) Patent Application Publication
(10) Pub. No.: US 2003/0025412 A1
(43) Pub. Date: Feb. 6, 2003

(54) Magnetic sleeve assembly

(76) Inventor: John Frederick Hayfield, San Diego, CA (US)

Correspondence Address: GERALD W SPINKS, P. O. BOX 2330, PORT ORCHARD, WA, 98366, US

(21) Appl. No.: 09/919,533

(22) Filed: Jul. 31, 2001

(51) Int. Cl. H02K 41/00

(52) U.S. Cl. 310/156.01; 310/13

(57) ABSTRACT

A magnetic sleeve assembly for use in a linear compressor motor, including a support sleeve and a plurality of magnets attached to the support sleeve by mounting rings. The mounting rings have angled lips extending over and contacting the ends of the magnets, which have beveled bearing surfaces on their ends. As the assembly expands and contracts, the mounting rings maintain the magnets in place.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention is in the field of linear electromechanical transducers, motors, or alternators, particularly as might be used in a linear refrigerant compressor motor.

2. Background Art

In the field of electromechanical alternators and motors, the generation of a time changing magnetic field in the vicinity of an electrical conductor can induce a voltage in the conductor, resulting in the flow of electrical current. Similarly, passing a time changing electrical current through an electrical conductor generates a time changing magnetic field, and this time changing magnetic field can be used to create mechanical motion. This principle is used to build motors for various uses, including motors used to drive refrigeration compressors.

In some refrigeration compressors, such as those used in cryogenic compressors, it can be beneficial to use a linear motor built on this principle. A cylindrical support sleeve can have a plurality of magnets mounted thereon, to create a magnetic assembly. This magnetic assembly can be mounted for linear translational, reciprocating, motion. Generation of a time changing electrical field imposes a time changing magnetic field on this magnetic assembly, causing it to reciprocate. The magnetic assembly can be attached to a compressor, to drive the compressor and compress the cryogenic refrigerant.

Known devices which utilize these design principles typically attach the magnets to the cylindrical support sleeve by the use of an adhesive. The adhesives used for this purpose may outgas in certain environments. Unfortunately, in some such compressors, this outgassing of the adhesive may introduce undesirable impurities into the flowpath of the cryogenic refrigerant. This can result in the plugging of small passages in the refrigerant flowpath, especially in miniature cryogenic systems, such as those used in some medical catheter systems.

### BRIEF SUMMARY OF THE INVENTION

The present invention includes a slotted cylindrical support sleeve to which are attached a plurality of magnets. Preferably, no adhesive is used in this magnetic assembly. The magnets may be attached to the support sleeve by circumferential support brackets which are in continuous contact with beveled bearing surfaces on the magnets. The support brackets may have angled lips which extend over and contact, along a line of contact, the beveled bearing surfaces on the magnets. As the magnets and the support sleeve expand and contract, the lips move up or down the beveled bearing surfaces on the magnets, maintaining continuous contact and continually forcing the magnets against the support sleeve.

Since, in certain embodiments, no adhesives are used, there is no harmful outgassing. Since, in certain embodiments, there are no spaces, or minimal spaces, between the support brackets and the magnets, the assembly is less prone to becoming loose.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a perspective view of a magnetic sleeve assembly according to the present invention;

FIG. 2 is a perspective view of the magnetic sleeve assembly shown in FIG. 1, from the opposite perspective;

FIG. 3 is a longitudinal section view of the magnetic sleeve assembly shown in FIG. 1;

FIG. 4 is an end elevation view of the magnetic sleeve assembly shown in FIG. 1;

FIG. 5 is a side elevation view of the magnetic sleeve assembly shown in FIG. 1; and

FIG. 6 is a partial section view, showing the relationship between the mounting bracket and the end of the magnet.

### DETAILED DESCRIPTION OF THE INVENTION

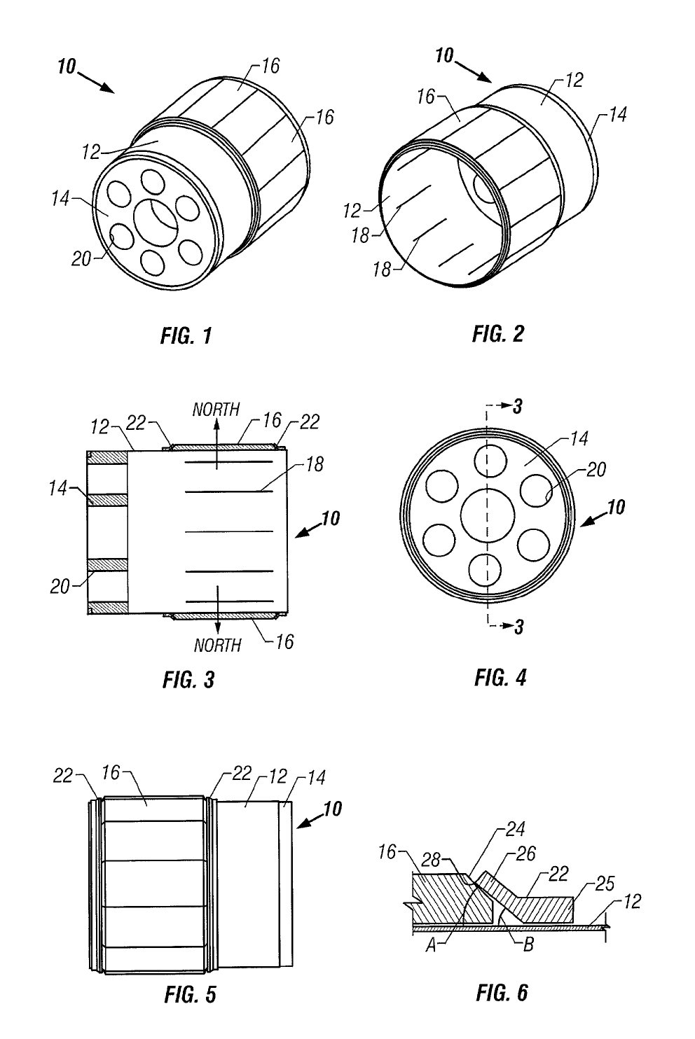

As shown in FIG. 1, the magnetic sleeve assembly 10 of the present invention may include a hollow metallic cylindrical support sleeve 12, a piston flange 14, and a plurality of peripherally mounted magnets 16. The support sleeve 12 is preferably constructed of a conducting metal. As better seen in FIG. 2, a plurality of longitudinal slots 18 may be formed through the wall of the support sleeve 12. Each magnet 16 may be mounted over one of the slots 18. A plurality of holes 20 may be formed through the piston flange 14, facilitating alignment and connection of the magnetic sleeve assembly 10 to a compressor (not shown).

As shown in FIGS. 3 through 5, the magnets 16 may be mounted on the external periphery of the support sleeve 12, with each magnet 16 having its North pole oriented radially outwardly from the support sleeve 12. Alternatively, they may have their south pole facing radially outwardly. Preferably, the magnets 16 are not mounted to the support sleeve 12 with an adhesive. In fact, preferably, no adhesives are used in the entire magnetic sleeve assembly 10. Instead, the magnets 16 are attached to the support sleeve 12 by two mounting brackets 22 in the form of metal rings attached peripherally to the external surface of the support sleeve 12. The mounting rings 22 can be attached to the support sleeve 12 by welding, brazing, or other mechanical attachment means.

One mounting ring 22 may be positioned adjacent to and extending over one end of each of the magnets 16. The other mounting ring 22 may be positioned adjacent to and extending over the other end of each of the magnets 16. This traps the magnets 16 between the two mounting rings 22 and holds the magnets 16 firmly against the support sleeve 12. Instead of the continuous mounting rings 22 shown, segmented mounting rings or brackets (not shown) could be used.

As shown in greater detail in FIG. 6, each end of each magnet 16 preferably has an annular beveled bearing surface 24 which faces generally radially outwardly from the support sleeve 12. The beveled bearing surfaces 24 on the ends of the magnets 16 are generally in annular alignment with each other. The mounting ring 22 has a base 25, which is mounted directly to the external peripheral surface of the support sleeve 12. The mounting ring 22 also has an angled lip 26 extending over the ends of the magnets 16, and contacting the beveled bearing surfaces 24 on the ends of the magnets 16. Upon installation, the angled lip 26 can flex slightly because of forcible contact with the magnet 16. Contact between the angled lip 26 of the mounting ring 22 and the beveled bearing surface 24 of the magnet 16 is along a single annular line of contact 28. The annular lines of contact 28 on the bearing surfaces 24 of the ends of the magnets 16 are generally in annular alignment with each other.

The beveled bearing surface 24 on the end of the magnet 16 is angled at a first acute angle A, relative to the wall of the support sleeve 12. The angled lip 26 on the mounting ring 22 is angled at a second acute angle B, relative to the wall of the support sleeve 12. The first acute angle A is greater than the second acute angle B, thereby insuring that contact between the beveled bearing surface 24 and the angled lip 26 is only along a single annular line of contact 28. The difference in magnitude between acute angle A and acute angle B is preferably less than approximately 10 degrees, and preferably in the range of approximately two degrees to approximately four degrees. The first acute angle A, for example, can be approximately 45 degrees, while the second acute angle B, for example, can be approximately 42 degrees.

If the magnet 16 contracts faster than the support sleeve 12, or if the support sleeve 12 expands faster than the magnet 16, the line of contact 28 will move downwardly along the beveled bearing surface 24 as the angled lip 26 straightens slightly. Conversely, if the magnet 16 expands faster than the support sleeve 12, or if the support sleeve 12 contracts faster than the magnet 16, the line of contact 28 will move upwardly along the beveled bearing surface 24, as the angled lip 26 flexes slightly further upwardly. In either case, secure contact is always maintained between the magnet 16 and the mounting ring 22.

It can be seen that, as differential thermal expansion takes place between the magnet 16 and the support sleeve 12, the line of contact 28 will move up or down along the beveled bearing surface 24, maintaining forcible contact at all times between the mounting ring 22 and the magnet 16. This continuous contact maintains an inward force at all times on the magnets 16, thereby always holding the magnets 16 securely in place longitudinally, without room for vibration.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

I claim:

1. A magnetic assembly, comprising:
a hollow cylindrical metal support sleeve;
at least one magnet positioned on a surface of said support sleeve;
at least one beveled bearing surface on said at least one magnet, said bearing surface being beveled at a first acute angle relative to said support sleeve;
at least one mounting bracket fastened to said support sleeve; and
at least one angled lip on said at least one mounting bracket contacting said at least one beveled bearing surface on said at least one magnet, thereby holding said at least one magnet in place on said support sleeve, said at least one lip extending at a second acute angle over said at least one beveled bearing surface.

2. The magnetic assembly recited in claim 1, further comprising at least one slot formed through a wall of said support sleeve, said at least one slot being oriented substantially parallel to the longitudinal axis of said support sleeve.

3. The magnetic assembly recited in claim 2, further comprising a plurality of said slots formed through said wall of said support sleeve.

4. The magnetic assembly recited in claim 1, wherein said first acute angle is greater than said second acute angle.

5. The magnetic assembly recited in claim 1, further comprising:
a plurality of said magnets positioned on said surface of said support sleeve; and
a plurality of beveled bearing surfaces on said plurality of magnets, each said bearing surface being beveled at a first acute angle relative to said support sleeve, each said bearing surface being contacted by said at least one lip on said at least one mounting bracket, angled at a second acute angle relative to said support sleeve, to hold said plurality of magnets in place on said support sleeve.

6. The magnetic assembly recited in claim 5, wherein:
said at least one bracket comprises at least one mounting ring circumferentially fastened to said support sleeve; and
said at least one angled lip extends from said at least one mounting ring over said plurality of beveled bearing surfaces on said plurality of magnets.

7. The magnetic assembly recited in claim 6, further comprising:
two of said beveled bearing surfaces on each said magnet, each said bearing surface being beveled at a first acute angle relative to said support sleeve; and
two of said mounting rings, each said mounting ring having an angled lip extending over one of said beveled bearing surfaces on each said magnet, each said lip being angled at a second acute angle relative to said support sleeve;
wherein said first acute angle is greater than said second acute angle.

8. The magnetic assembly recited in claim 7, wherein said first acute angle is greater than said second acute angle by between two degrees and four degrees.

9. The magnetic assembly recited in claim 8, wherein said first acute angle is about 45 degrees.

10. The magnetic assembly recited in claim 1, wherein said at least one angled lip contacts said at least one beveled bearing surface along a single line of contact.

11. The magnetic assembly recited in claim 1, wherein said at least one magnet is positioned on an outer peripheral surface of said support sleeve.

12. The magnetic assembly recited in claim 1, wherein the north pole of said at least one magnet is oriented radially outwardly from said support sleeve.

13. A magnetic assembly, comprising:
a hollow cylindrical metal support sleeve;
a plurality of magnets positioned on an outer peripheral surface of said support sleeve;
two beveled bearing surfaces on each said magnet, each said bearing surface being beveled at a first acute angle relative to said support sleeve;
two mounting rings fastened to said support sleeve at spaced apart locations, with said plurality of magnets being positioned between said mounting rings; and
an angled lip on each said mounting ring contacting one of said beveled bearing surfaces on each said magnet, thereby holding said plurality of magnets in place on said support sleeve, said angled lips extending at a second acute angle over said beveled bearing surfaces.

14. The magnetic assembly recited in claim 13, further comprising a plurality of slots formed through a wall of said support sleeve, said plurality of slots being oriented substantially parallel to the longitudinal axis of said support sleeve.

15. The magnetic assembly recited in claim 13, wherein said first acute angle is greater than said second acute angle.

16. The magnetic assembly recited in claim 13, wherein said first acute angle is greater than said second acute angle by between two degrees and four degrees.

17. The magnetic assembly recited in claim 16, wherein said first acute angle is about 45 degrees.

18. The magnetic assembly recited in claim 13, wherein each said angled lip contacts each said beveled bearing surface along a single line of contact.

19. The magnetic assembly recited in claim 13, wherein the north poles of said plurality of magnets are oriented radially outwardly from said support sleeve.
